(19) United States
(12) Patent Application Publication
(10) Pub. No.: US 2017/0221658 A1
(43) Pub. Date: Aug. 3, 2017

(54) EMBEDDED POLE AND METHODS OF ASSEMBLING SAME

(71) Applicant: General Electric Company, Schenectady, NY (US)

(72) Inventors: Rui XING, Shanghai (CN); Beibei JING, Shanghai (CN); Qiyou XU, Shanghai (CN); Xuewei SUN, Shanghai (CN); Ming WU, Xian (CN)

(21) Appl. No.: 15/409,596

(22) Filed: Jan. 19, 2017

(30) Foreign Application Priority Data
Jan. 28, 2016 (CN) 201610057721.5

(51) Int. Cl. H01H 33/66; H01H 11/00

(52) U.S. Cl. CPC H01H 33/6606; H01H 11/00; H01H 2033/6613

(57) ABSTRACT

An embedded pole is provided. The embedded pole includes an insulation shell, a conductive circuit, wherein at least a portion of the conductive circuit is housed within the insulation shell, and a ventilation system including an external heat sink coupled to the conductive circuit and external to the insulation shell, and an internal heat sink coupled to the conductive circuit and positioned within the insulation shell.

### BACKGROUND

The field of the invention relates generally to embedded poles for use in switching devices, and more particularly, to embedded poles including external and internal heat sinks.

Embedded poles may be implemented in a switching device, such as a medium voltage circuit breaker. At least some known embedded poles include conductive components and non-conductive (i.e., insulating) components. Insulating components generally have limited heat dissipation capabilities.

However, during a short circuit event, relatively high amounts of current may be conducted through an embedded pole. Accordingly, embedded poles become relatively hot relatively quickly, which may damage insulating components in the embedded poles. As such, an embedded pole should be able to dissipate heat relatively quickly to avoid damage thereto.

### BRIEF DESCRIPTION

In one aspect, an embedded pole is provided. The embedded pole includes an insulation shell, a conductive circuit, wherein at least a portion of the conductive circuit is housed within the insulation shell, and a ventilation system including an external heat sink coupled to the conductive circuit and external to the insulation shell, and an internal heat sink coupled to the conductive circuit and positioned within the insulation shell.

In another aspect, a ventilation system for use with an embedded pole, the ventilation system including an external heat sink configured to be coupled to a conductive circuit of the embedded pole and positioned external to an insulation shell of the embedded pole, and an internal heat sink configured to be coupled to the conductive circuit and positioned within the insulation shell.

In yet another aspect, a method of assembling an embedded pole is provided. The method includes coupling an external heat sink to a conductive circuit that includes an upper terminal and a lower terminal, coupling an internal heat sink to the conductive circuit, and housing at least a portion of the conductive circuit in an insulation shell, such that the external heat sink is external to the insulation shell and the internal heat sink is positioned within the insulation shell.

### BRIEF DESCRIPTION OF THE DRAWINGS

FIG. 1 is a perspective view of an exemplary embedded pole.

FIG. 2 is a perspective view of the embedded pole shown in FIG. 1 with an insulation shell omitted.

FIG. 3 is a side view of a conductive circuit that may be used with the embedded pole shown in FIG. 1.

FIG. 4 is a perspective view of the embedded pole shown in FIG. 1.

FIG. 5 is a side view of the embedded pole shown in FIG. 1.

FIG. 6 is a top view of an external heat sink that may be used with the embedded pole shown in FIG. 1.

FIG. 7 is a side view of the external heat sink shown in FIG. 6.

FIG. 8 is a top view of an alternative external heat sink that may be used with the embedded pole shown in FIG. 1.

FIG. 9 is a side view of the external heat sink shown in FIG. 8.

FIG. 10 is a schematic view of a portion of the embedded pole shown in FIG. 1.

FIG. 11 is a schematic view of a portion of the embedded pole shown in FIG. 1 with semicircular parts added.

### DETAILED DESCRIPTION

The systems and methods described herein provide an embedded pole with an external heat sink and an internal heat sink. The external and internal heat sinks provide improved heat dissipation capabilities, as compared to at least some known embedded poles. Further, an insulation shell of the embedded pole defines a flow path that further facilitates improved heat dissipation.

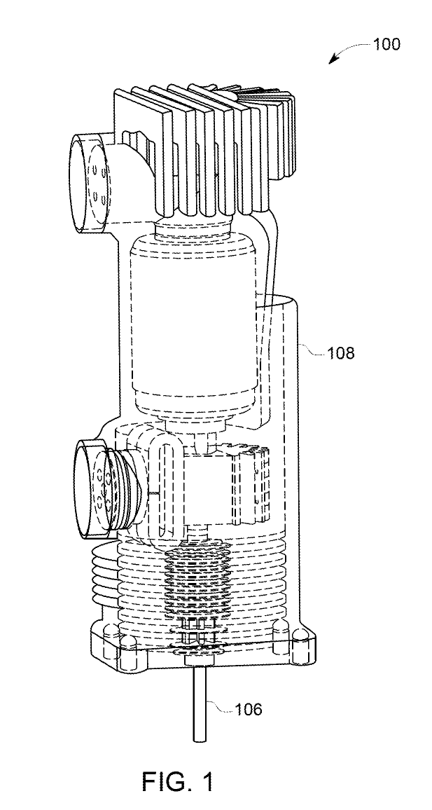

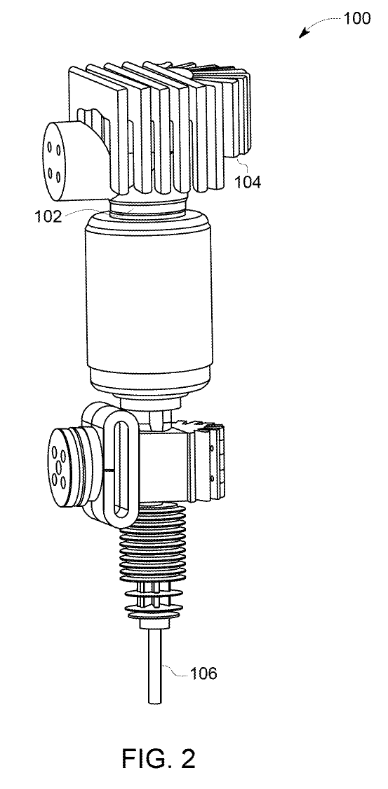

FIGS. 1 and 2 are perspective views of an exemplary embedded pole 100. Embedded pole 100 may be used, for example, to provide an electrical connection between two components in a medium voltage circuit breaker. Embedded pole 100 includes a conductive circuit 102, a ventilation system 104, an insulation rod 106, and an insulation shell 108. Insulation rod 106 and insulation shell 108 are made of a suitable insulating material. Insulation shell 108 houses at least a portion of conductive circuit 102, ventilation system 104, and insulation rod 106. For clarity, insulation shell 108 is shown as partially transparent in FIG. 1, and insulation shell 108 is omitted in FIG. 2.

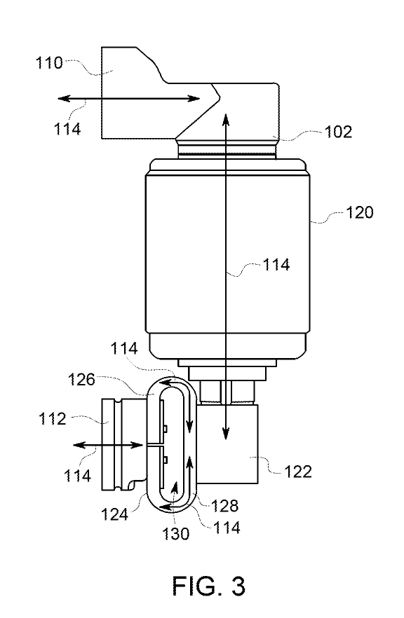

FIG. 3 is a side view of conductive circuit 102. Conductive circuit 102 electrically connects two components. Specifically, conductive circuit 102 includes an upper terminal 110 that couples to a first component, and a lower terminal 112 that couples to a second component. Conductive circuit 102 provides a current path 114 that electrically connects the first and second components when the first component is coupled to upper terminal 110 and the second component is coupled to lower terminal 112.

As shown in FIG. 3, in the exemplary embodiment, current path 114 passes through a vacuum interrupter 120 and a bushing 122 electrically coupled between upper and lower terminals 110 and 112. Further, lower terminal 112 is connected to bushing 122 via a conductive flexible connection 124. In the exemplary embodiment, all components of conductive circuit 102 are copper. Alternatively, components of conductive circuit 102 may be made of any material that enables conductive circuit 102 to function as described herein. A first end of insulation rod 106 (shown in FIGS. 1 and 2) is coupled to a moveable end of vacuum interrupter 120, and a second end of insulation rod 106 is coupled to a mechanical driving system (not shown).

In the exemplary embodiment, flexible connection 124 includes an upper u-shaped arm 126 and a lower u-shaped arm 128. Lower terminal 112 couples to both upper and lower u-shaped arms 126 and 128, as shown in FIG. 3. Further, during operation, current flows through both upper and lower u-shaped arms 126 and 128. Notably, flexible connection 124 allows lower terminal 112 to be selectively adjusted and moved relative to other components of conductive circuit 102 (e.g., vacuum interrupter 120 and upper terminal 110). This assists in coupling lower terminal 112 to the second component.

Moreover, the configuration of flexible connection 124 and lower terminal 112 also provides heat dissipation benefits during operation of embedded pole 100. Specifically, an aperture 130 formed through flexible connection 124 allows air to contact and pass through flexible connection 124 to cool flexible connection 124. Further, lower terminal 112 is smaller and has a larger contact surface relative to at least some known embedded pole terminals, further enhancing heat dissipation.

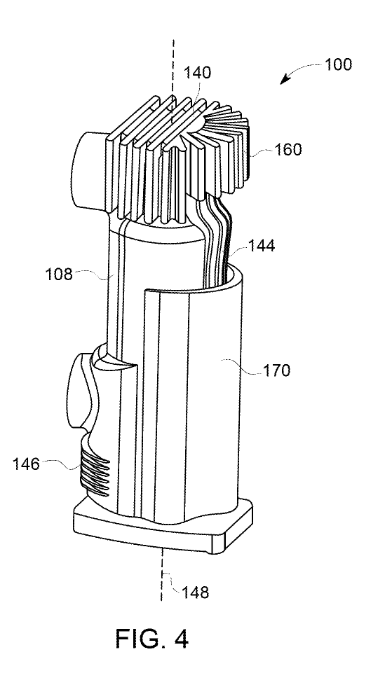

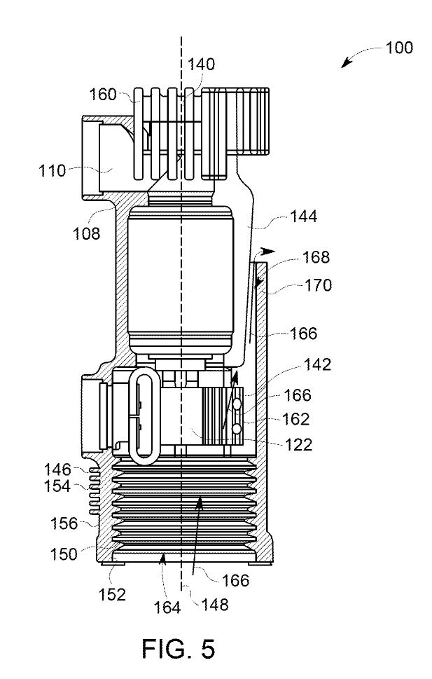

FIGS. 4 and 5 illustrate operation of ventilation system 104 of embedded pole 100. FIG. 4 is a perspective view of embedded pole 100 including insulation shell 108. FIG. 5 is a side view of embedded pole 100 with a portion of insulation shell 108 removed for clarity. Ventilation system 104 facilitates dissipating heat from embedded pole 100.

As shown in FIGS. 4 and 5, ventilation system 104 includes an external heat sink 140 and an internal heat sink 142. External heat sink 140 is substantially external to insulation shell 108, while internal heat sink 142 is internal to insulation shell 108. External heat sink 140 is coupled to upper terminal 110, and internal heat sink 142 is coupled within insulation shell 108 to bushing 122. External heat sink 140 facilitates dissipating heat from upper terminal 110, and internal heat sink 142 facilitates dissipating heat from inside insulation shell 108.

Insulation shell 108 also includes a plurality of heat dissipating features. In the exemplary embodiment, insulation shell 108 includes a first set 144 of ventilation ribs and a second set 146 of ventilation ribs. The ventilation ribs in first set 144 extend vertically (i.e., substantially parallel to a longitudinal axis 148 of insulation shell 108). The ventilation ribs in second set 146 extend substantially circumferentially about longitudinal axis 148. In the exemplary embodiment, second set 146 includes inner ribs 150 on an inner surface 152 of insulation shell 108 and outer ribs 154 on an outer surface 156 of insulation shell 108. Alternatively, insulation shell 108 may include any number and/or configuration of ventilation ribs that enables insulation shell 108 to function as described herein.

External heat sink 140 and internal heat sink 142 include fins 160 and 162, respectively. As shown in FIG. 5, internal heat sink 142 facilitates dissipating heat from an internal cavity 164 of insulation shell 108. Specifically, air flows along a flow path 166 through internal cavity 164, through fins 162, and through a ventilation channel 168 formed in insulation shell 108. That is, internal cavity 164 is in fluid communication with ventilation channel 168. The configuration of flexible connection 124 and lower terminal 112 increases the volume of internal cavity 164 through which air can flow through. In the exemplary embodiment, ventilation channel 168 is defined by first set 144 of ventilation ribs and an outer wall 170 of insulation shell 108.

Due to ventilation system 104 and ventilation channel 168, embedded pole 100 is able to meet a 1.1×3150 Ampere (A) (i.e., 3465 A) temperature rise requirement under natural ventilation conditions. At least some known embedded poles do not include a ventilation system and/or ventilation channel as described herein. Such known embedded poles are not able to meet a 1.1×3150 Ampere (A) temperature rise requirement under natural ventilation conditions. Further, embedded pole 100 is less expensive to manufacture than at least some known embedded poles.

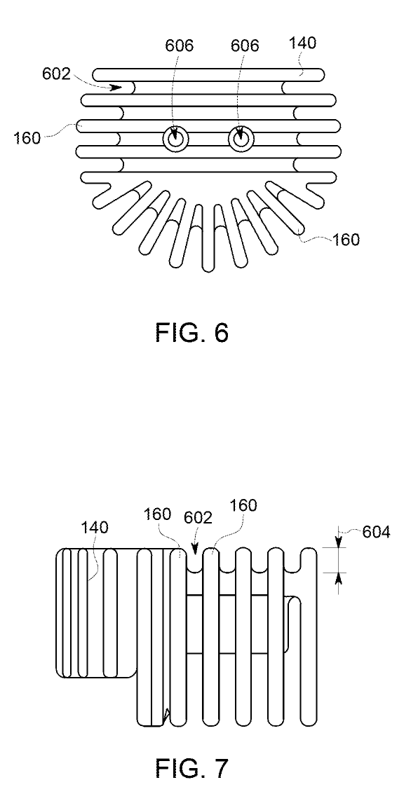

FIG. 6 is a top view of external heat sink 140. FIG. 7 is a side view of external heat sink 140. As shown in FIGS. 6 and 7, grooves 602 are defined between at least some fins 160. Grooves 602 facilitate separating fins 160 and dissipating heat. Each groove has a corresponding depth 604. Depth 604 may be, for example, approximately 10 millimeters (mm). External heat sink 140 also includes at least one attachment aperture 606 defined therethrough to facilitate attaching external heat sink 140 to upper terminal 110. In the exemplary embodiment, external heat sink 140 includes two attachment apertures 606. Alternatively, external heat sink 140 may include any number of attachment apertures 606 that enables external heat sink 140 to function as described herein.

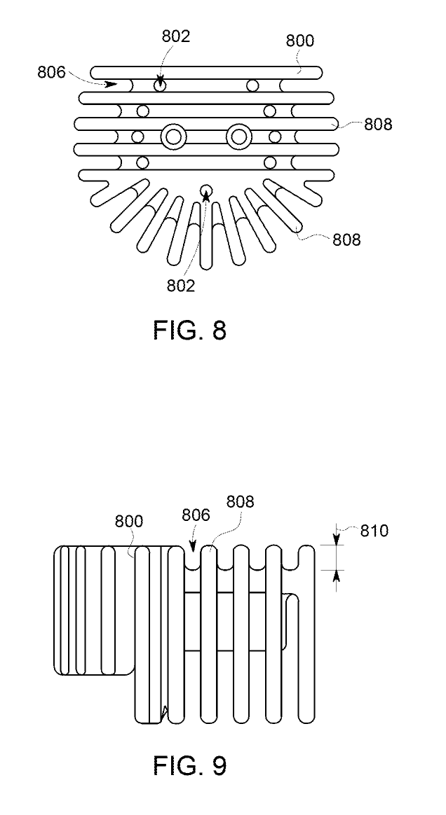

FIG. 8 is a top view of an alternative external heat sink 800. FIG. 9 is a side view of external heat sink 800. Unless otherwise indicated, external heat sink 800 is substantially similar to external heat sink 140. As shown in FIG. 8, external heat sink 800 includes a plurality of cooling holes 802 defined therethrough. Cooling holes 802 facilitate increased heat dissipation capabilities of external heat sink 800 relative to external heat sink 140. In the exemplary embodiment, external heat sink 800 includes nine cooling holes 802. Further, eight cooling holes 802 are positioned at the bottom of grooves 806 defined between fins 808. Alternatively, external heat sink 800 may include any number and configuration of cooling holes 802 that enables external heat sink 800 to function as described herein.

As shown in FIG. 9, a depth 810 of grooves 806 is larger than depth 604 of grooves 602 (shown in FIGS. 6 and 7). For example, depth 810 may be approximately 20 mm. The increased depth 810 facilitates increased heat dissipation capabilities of external heat sink 800 relative to external heat sink 140.

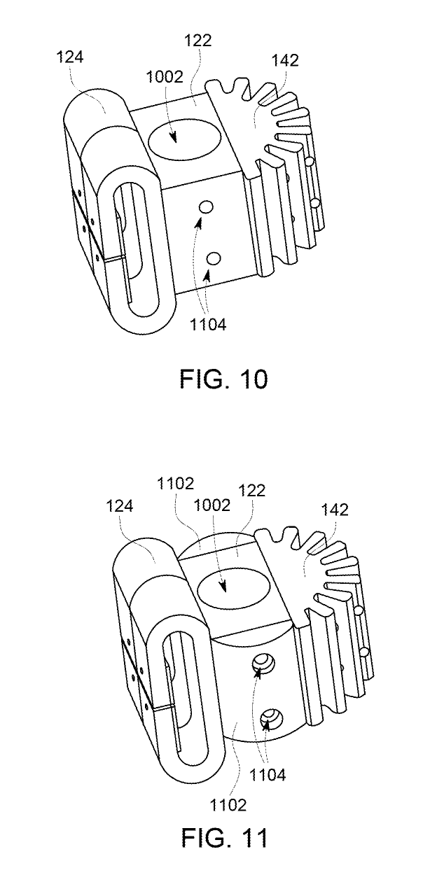

FIG. 10 is a schematic view of flexible connection 124, bushing 122, and internal heat sink 142. As shown in FIG. 10, bushing 122 defines an aperture 1002 for receiving insulation rod 106. In some embodiments, as shown in FIG. 11, semicircular parts 1102 are attached to bushing 122. Semicircular parts 1102 increase an effective surface area of bushing 122 and facilitate increasing heat dissipation capabilities of embedded pole 100. In this embodiment, semicircular parts 1102 and bushing 122 each include fastener holes 1104 to facilitate attaching semicircular parts 1102 to bushing 122 using one or more fasteners (not shown). Alternatively, semicircular parts 1102 may be coupled to bushing 122 using any technique that enables bushing 122 to function as described herein.

The embodiments described herein provide an embedded pole with an external heat sink and an internal heat sink. The external and internal heat sinks provide improved heat dissipation capabilities, as compared to at least some known embedded poles. Further, an insulation shell of the embedded pole defines a flow path that further facilitates improved heat dissipation.

Exemplary embodiments of systems and methods for embedded poles are described above in detail. The systems and methods are not limited to the specific embodiments described herein but, rather, components of the systems and/or operations of the methods may be utilized independently and separately from other components and/or operations described herein. Further, the described components and/or operations may also be defined in, or used in combination with, other systems, methods, and/or devices, and are not limited to practice with only the systems described herein.

Although exemplary embodiments have been described above with a certain degree of particularity, those skilled in the art could make numerous alterations to the disclosed embodiments without departing from the spirit or scope of this disclosure. All directional references (e.g., upper, lower, upward, downward, left, right, leftward, rightward, top, bottom, above, below, vertical, horizontal, clockwise, and counterclockwise) are only used for identification purposes to aid the reader's understanding of the disclosure, and do not create limitations, particularly as to the position, orientation, or use of the disclosure. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting.

The order of execution or performance of the operations in the embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An embedded pole comprising:
an insulation shell;
a conductive circuit, wherein at least a portion of the conductive circuit is housed within said insulation shell; and
a ventilation system comprising:
an external heat sink coupled to said conductive circuit and external to said insulation shell; and
an internal heat sink coupled to said conductive circuit and positioned within said insulation shell.

2. An embedded pole in accordance with claim 1, wherein said conductive circuit comprises:
an upper terminal;
a lower terminal;
a vacuum interrupter coupled between said upper and lower terminals;
a bushing coupled between said vacuum interrupter and said lower terminal; and
a flexible connection coupling said bushing to said lower terminal.

3. An embedded pole in accordance with claim 2, wherein said flexible connection comprises an upper u-shaped arm and a lower u-shaped arm that define an aperture therebetween.

4. An embedded pole in accordance with claim 2, further comprising at least one semicircular part coupled to said bushing.

5. An embedded pole in accordance with claim 1, wherein said insulation shell comprises:
a plurality of ventilation ribs extending parallel to a longitudinal axis of said insulation shell; and
an outer wall, wherein a ventilation channel is defined by said plurality of ventilation ribs and said outer wall, the ventilation channel facilitating heat dissipation from said embedded pole.

6. An embedded pole in accordance with claim 5, wherein said internal heat sink is positioned within an internal cavity of said insulation shell.

7. An embedded pole in accordance with claim 6, wherein the internal cavity and the ventilation channel form a flow path for dissipating heat from said embedded pole.

8. An embedded pole in accordance with claim 1, wherein said external heat sink comprises a plurality of fins, wherein grooves are defined between at least some fins of said plurality of fins.

9. An embedded pole in accordance with claim 8, wherein each groove has a depth of at least 10 millimeters.

10. An embedded pole in accordance with claim 9, wherein each groove has a depth of approximately 20 millimeters.

11. An embedded pole in accordance with claim 1, wherein a plurality of cooling holes are defined through said external heat sink.

12. A ventilation system for use with an embedded pole, said ventilation system comprising:
an external heat sink configured to be coupled to a conductive circuit of the embedded pole and positioned external to an insulation shell of the embedded pole; and
an internal heat sink configured to be coupled to the conductive circuit and positioned within the insulation shell.

13. A ventilation system in accordance with claim 12, wherein said external heat sink comprises a plurality of fins, wherein grooves are defined between at least some fins of said plurality of fins.

14. A ventilation system in accordance with claim 13, wherein each groove has a depth of at least 10 millimeters.

15. A ventilation system in accordance with claim 14, wherein each groove has a depth of approximately 20 millimeters.

16. A ventilation system in accordance with claim 12, wherein a plurality of cooling holes are defined through said external heat sink.

17. A method of assembling an embedded pole, said method comprising:
coupling an external heat sink to a conductive circuit that includes an upper terminal and a lower terminal;
coupling an internal heat sink to the conductive circuit; and
housing at least a portion of the conductive circuit in an insulation shell, such that the external heat sink is external to the insulation shell and the internal heat sink is positioned within the insulation shell.

18. A method in accordance with claim 17, wherein housing at least a portion of the conductive circuit comprises housing at least a portion of the conductive circuit in an insulation shell that defines an interior cavity and a ventilation channel, wherein the internal heat sink is positioned within the interior cavity, and wherein the ventilation channel forms a flow path with the interior cavity for dissipating heat from the internal heat sink.

19. A method in accordance with claim 17, wherein coupling an external heat sink to a conductive circuit comprises coupling the external heat sink to a conductive circuit that includes a vacuum interrupter coupled between the upper and lower terminals, a bushing coupled between the vacuum interrupter and the lower terminal, and a flexible connection coupling the bushing to the lower terminal.

20. A method in accordance with claim 17, wherein coupling an external heat sink to a conductive circuit comprises coupling an external heat sink having a plurality of cooling holes defined therethrough.
